(19) United States
(12) Patent Application Publication
(10) Pub. No.: US 2010/0182776 A1
(43) Pub. Date: Jul. 22, 2010

(54) Battery-powered light system

(76) Inventors: Charles Boyce, New York, NY (US); David Boyce, Damascus, PA (US); Jesse Guss, Matawan, NJ (US); Jamie Guss, New York, NY (US); Yaniv Avital, Modiin (IL)

Correspondence Address: WILLIAM J. MASON;MACCORD MASON PLLC, POST OFFICE BOX 1489, WRIGHTSVILLE BEACH, NC, 28480, US

(21) Appl. No.: 12/653,622

(22) Filed: Dec. 16, 2009

Related U.S. Application Data
(60) Provisional application No. 61/201,972, filed on Dec. 17, 2008.

(51) Int. Cl. F21L 4/02; H05B 37/02

(52) U.S. Cl. 362/184; 315/294

(57) ABSTRACT

Hand-carried, battery-powered light replacing conventional bank lights are described. In one embodiment, the light includes a generally rectangular body with opposed faces, a peripheral edge having a width substantially less than the width of the faces, and a handle adjacent one end of the body; and a plurality of spaced LED emitter heads mounted on one face of the body, each of the emitter heads including a housing and at least one LED emitter. In another embodiment, the light includes a non-conductive enclosure having rectangular top and bottom walls, and side and end walls connecting the top and bottom walls, the top wall including receiving recesses; and a plurality of rotatable light sources mounted on the top wall, each of the light sources including a telescopic support post having a base end pivotally attached to the top wall and an outer end, and an LED emitter head attached to the outer end of the post.

This application claims the benefit of the filing date of U.S. Provisional Application Ser. No. 61/201,972, filed Dec. 17, 2008, and entitled Battery-Powered Light System, the entire contents of which are incorporated herein by reference.

### BACKGROUND OF THE INVENTION

(1) Field of the Invention

The present invention relates generally to battery-powered work lights, and in particular to work lights that can be carried by hand or temporarily mounted for use by, but not exclusive by, rail transit workers. The hand-carried lights may have the shape and appearance of conventional bank lights, or may be a self-contained unit with a plurality of LED light sources.

(2) Description of the Prior Art

Historically, warning devices known as bank lights have been used by transit workers to indicate when current is flowing through the third rail of a transit railway system. In a typical configuration, a bank light is comprised of five 120 W incandescent light bulbs mounted on a wooden paddle. The light bulbs are wired in series and connectable to the 600V third rail and one of the running rails with alligator clips. The paddle normally includes a clip used to hang the bank light on wiring adjacent the track. The bulbs then illuminate to warn the workers when the third rail is energized.

Over time, transit workers have also become accustomed to using banks lights as a source of illumination while working with the bank lights being attached to the live third rail. This practice can be extremely hazardous since the worker is working in the vicinity of the live rail. In addition, failure of even one incandescent bulb causes the light to fail to illuminate, indicating that there is no current in the rail when the rail is in fact energized. Moreover, when the rail is not energized, the bank light is of no use as a work light.

Workers, however, have become accustomed to the shape and configuration of the bank light and are reluctant to replace the bank light with other types of illumination. Therefore, it is one objective of the present invention to provide a work light having the shape and configuration of the conventional bank light without the aforesaid hazards. It is another objective of the present invention to provide other work lights of value to transit workers, as well as others, that are based on the same primary components as the improved work light.

### SUMMARY OF THE INVENTION

### Embodiment 1

The work light of the first embodiment is comprised of a non-conductive paddle having a size and shape similar to a conventional bank light paddle. That is, the paddle has a generally rectangular body with opposed faces and a peripheral edge having a width substantially less than the width of the faces. The paddle also includes an ergonomic handle attached to one end of the body.

A plurality of spaced LED heads are mounted inline along the longitudinal axis of the paddle on one face of the paddle body. Each head is comprised of a finned housing, LED emitters, a microprocessor controlled dc buck and boost voltage regulator and a switch. A preferred emitter is the LXML-PWC1-0100 Luxeon® Rebel Cool or similar to emitter capable of delivering 180 lumens when driven at 700 Ma. Three emitters are mounted on an aluminum circuit card which is then mechanically fastened within the heat sink housing. Each head is capable of emitting 7 plus footcandles at seven feet which may be adjusted with diffusion and electronics.

The LED emitter may be used with a diffuser flood lens or a narrow beam lens. Light output qualities may be influenced by holographic nanotechnology diffusion films such as or similar to Luminit White™ Holographic Diffuser, which belong to a new family of hybrid diffusers combining the strengths of the industry proven holographic diffuser and bulk diffusing technologies. A wide range of micro-surface topographies and an unlimited tunability of opacity come together in this new or similar to, Luminit White product to give unprecedented levels of diffusion at short working distances. Key applications include diffusing situations where the working distance between the source and the observer is extremely limited. This nanotechnology-based application, allows large custom angle diffusing with reduced working distances.

Each emitter head is connected to a master module which includes a battery, component circuitry to provide charge monitoring, fuel/power gauge, short circuit protection and low voltage cutoff. The work light systems may have any number of heads as required for lighting requirements. In one instance, four heads may be used, while in another instance two modules may be used. The housings of the heads are constructed of a translucent plastic for non-blinding side illumination.

Depending upon the manner in which the work light is used, other optional components may be included. For example, a hang bracket may be attached so that the work light can hang on existing conduits for track side use. The hang bracket is attached so that the work light will hang at the same orientation as conventional bank lights positioning the work light so that it shines outward and downward so that the light will not shine in train operators eyes. When the work light is designed primarily to be carried by the worker, the light may include a belt clip or carrying strap.

In addition to, or instead of, batteries and charging port, the foregoing four head model may include two leads, which may be retractable for use in connecting the unit to the third rail similar to the existing bank light. The leads include a magnetic connection for the electrified rail which is small, safe to connect, and drops the output voltage down to a low voltage to power the light thus preventing 600V from entering the light or being around the work area.

Using the above power sources, the current invention provides for interfaces that enable all units to run on virtually any available power. Thus, a battery version is available for 53 hour general orders and quick maintenance or for whenever battery power makes sense, such as for power off General Orders. Also, a plug-in version is available for indefinite illumination when AC or DC power is available with interfaces so station power could also be used.

In addition, an improved method for connection to the 600 volt rail is provided, eliminating 600 volt leads tangled in and around the work area. Lights can be powered with lightweight light gauge cable which can neatly stores itself within the chassis of the unit. Lighting using LED technology is provided in a very indestructible form factor.

### Embodiment 2

As an alternative to mounting the LED head on a paddle as described above, a plurality of LED heads having the aforesaid construction may be mounted in a rectangular holder that includes a battery power source, preferably a lithium ion battery pack, with the heads being oriented as desired during use. For example, four heads may be pivotally secured and protected within recesses in the top wall of a rectangular stackable enclosure that also includes a retractable carrying handle. The enclosure also includes a bottom wall, side walls and end walls that together form a battery compartment.

When used, one or more of the heads can be pivoted to an upright position and rotated as desired to shine their lights on the work area. With a four head pack, 360° of illumination is possible. In addition, non-conductive telescoping, extension poles, e.g., carbon fiber poles, can be included to support the heads at a greater height above the housing. The housing is preferably constructed of or similar to ultra high molecular weight polyethylene (UHMW) to provide ultra high abrasion resistance and impact strength. The housings can be stacked for storage and charging. The pack can also include a carry strap, “owner only” charging security system, and battery fuel gauge. A gang style charging rail or trough electronically licensed to owner can replace the independent charging system to prevent units being stolen or used unauthorized. This rail would also be a docking station to store and charge multiples of units.

The LED heads can also be removed from the pack and connected to the pack by a cable or to any other power source that can deliver 750 mA at 10-50 VDC, making the heads ideal for 12, 24 or 48 VDC operation virtually anywhere any power source is available. The heads may include magnets, e.g., neodymium iron-boron (NdFeB) magnets, to affix the heads to any ferrous surface.

The lights of Embodiment 2 may also be housed within a rectangular, non-conductive protective housing that includes a window for light transmission, a power switch and a carry strap.

### Circuitry

The three LED emitters of each of the heads in the above embodiments are preferably connected to a DC-DC buck boost, e.g., based on or similar to the Texas Instruments TI 63000 series IC series, to provide constant current, and a microcontroller for LED control. The emitter heads are independently connected to a battery power source that includes a lithium ion battery pack, a charger and microcontroller.

### BRIEF DESCRIPTION OF THE DRAWINGS

FIG. 1 is a perspective view of Embodiment 1 with four LED heads.

FIG. 2 is a perspective view of Embodiment 1 with two LED heads.

FIG. 3 is a perspective view of Embodiment 2 with four LED head light sources.

FIG. 4 is a top view of Embodiment 2 with four LED head light sources.

FIG. 5 is a top view of Embodiment 2 with two LED head light sources.

FIG. 6 is a top view of another example of Embodiment 2 with two LED head light sources.

FIG. 7 is a circuit diagram of the light.

FIG. 8 is a perspective view of a housing for a hand-carried light.

FIG. 9 is a perspective view of a housing for another hand-carried light.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

Work light, generally 10, illustrated in FIG. 1 is comprised of a non-conductive paddle 12 having mounted on one face thereof four LED heads 14 spaced equidistant along the longitudinal axis of paddle 12. Each head 14 is comprised of a translucent housing 16, LED emitters 18 mounted in housing 16, and an on-off button 20. Light 10 also includes a hang bracket 22 and carrying or hang cord 24.

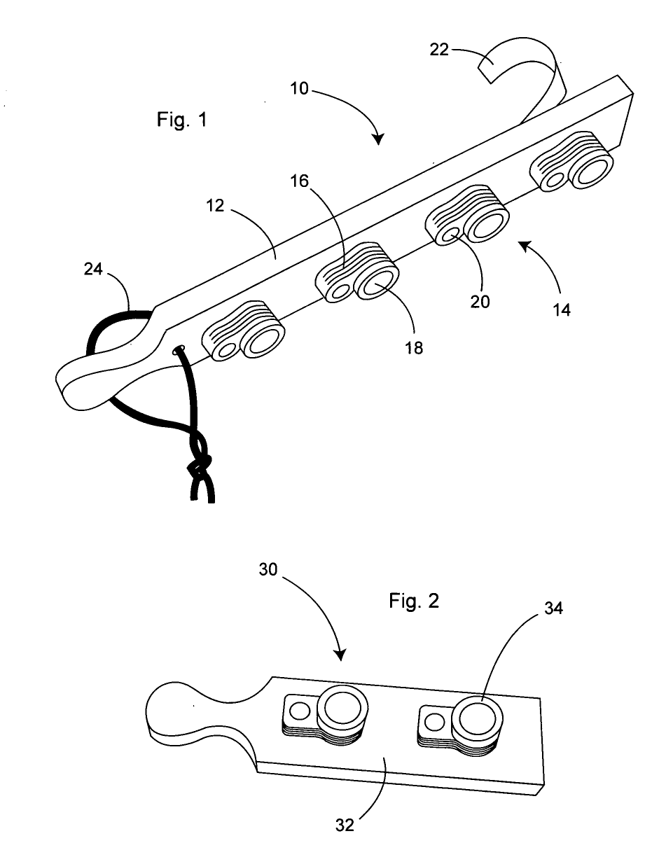

Work light, generally 30, illustrated in FIG. 2 is designed primarily to be hand carried, and is comprised of a relatively smaller non-conductive paddle 32 having mounted on one face thereof two LED heads 34 spaced equidistant along the longitudinal axis of paddle 12. Heads 34 or similar in construction to heads 14.

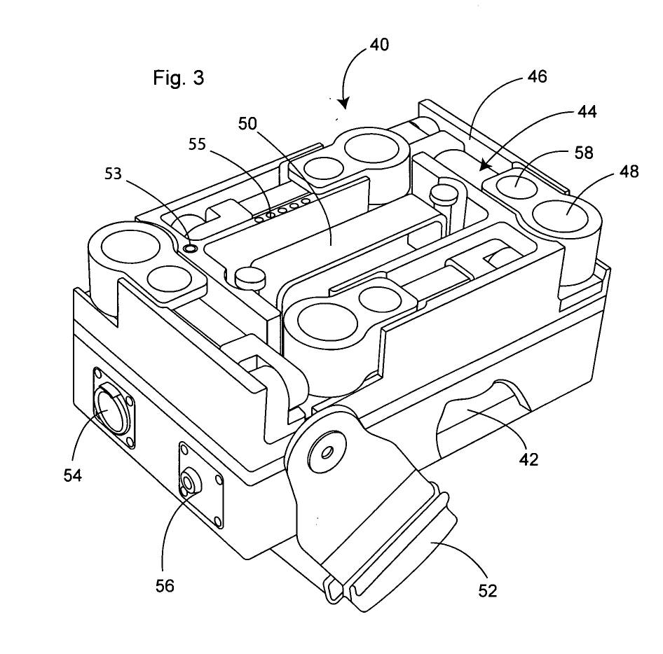

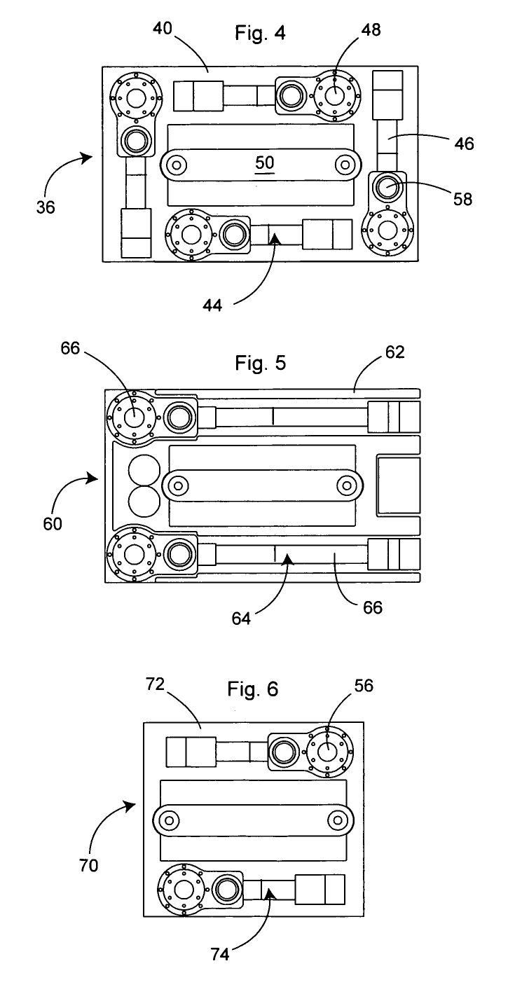

FIGS. 3 and 4 illustrate an example of Embodiment 2, a hand-carried light, generally 36, comprised of a non-conductive, impact resistant enclosure 40 designed to enclose a rechargeable battery pack 42. Enclosure 40 is configured to carry four pivotally mounted LED light sources 44 in recesses 46 on the top wall of enclosure 40. Each LED light source 44 is comprised of a post 46 which has a base end pivotally attached to enclosure 40 and a top end to which is attached LED head 48. Head 48 is also capable of rotation. Pivoting and rotation enables the LED heads to direct light in any direction. Therefore, with four LED light sources 44, it is possible to direct light 360°. Light 36 also includes a carrying handle 50, a carrying strap 52, a capacitive touch fuel gauge switch 53, a charging port 54, a fuel gauge indicator including fuel gauge “lite pipes” 55, and a high/low keyswitch 56. Each LED head 48 also includes an on/off switch 58.

FIG. 4 illustrates another example of another hand-carried light 60, and is also comprised of a non-conductive, impact resistant enclosure 62 designed to enclose a battery pack (not shown). Enclosure 62 is configured to hold two pivotally mounted LED light sources 64, each including a telescopic post 66 and a rotatable LED head 66. Light sources 64 differ from light sources 44 in that head 66 is extendable to a greater height above enclosure 62 due to the use of longer telescoping posts 66.

FIG. 6 illustrates another example of a hand-carried light 70, and is also comprised of a non-conductive, impact resistant enclosure 72 designed to enclose a battery pack (not shown). Enclosure 72 includes two pivotally mounted LED light sources 74, which are capable of orientation without the extension feature of the heads of FIG. 5. The Example of FIG. 6 has 540 lumens per head @ 3.85 volts @ 2100 mA for a total of 1080 lumens. The foot-candles per head is 7.25 or a total of 14.5 foot-candles. This example has a run time per head of 25.05 hours, or 12.53 hours when running both heads, with an operating current @ 2100 mA per head, with a 3.85 VDC forward voltage, using a 4.22 volt battery, with a 50 Ah capacity, using 96% efficiency electronics.

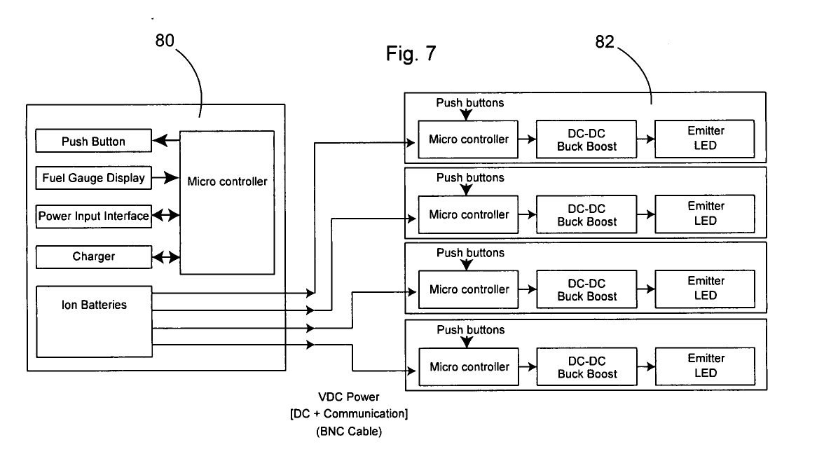

FIG. 7 schematically illustrates a typical circuit for either Embodiment 1 or 2, and is comprised of a battery pack 80 and a plurality of heads 82 which are independently powered by battery pack 80.

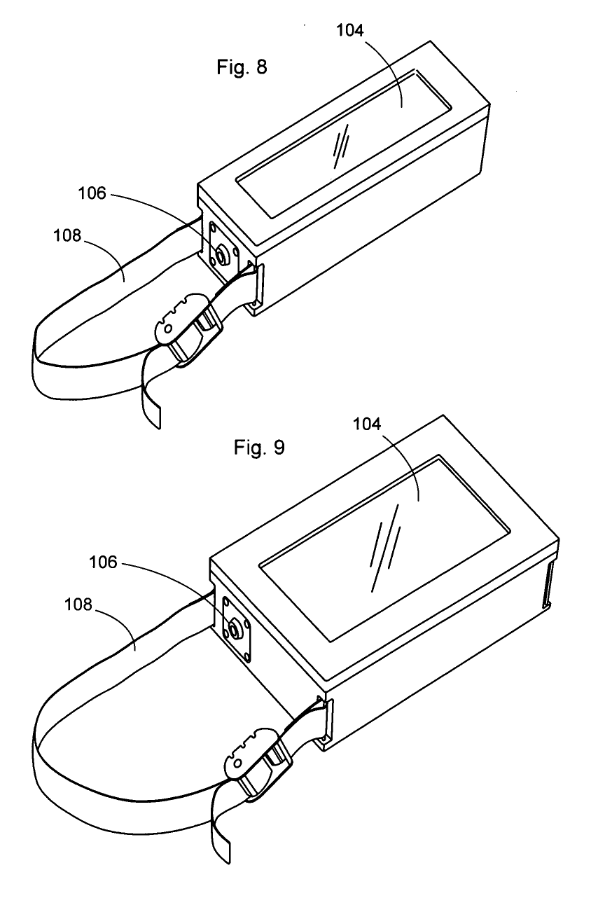

FIGS. 8 and 9 are representative illustrations of housings, generally 100 and 102, that can be used to enclose of light having the configuration of Embodiment 2. Each housing includes a light transmission window 104, which may be transparent or translucent, a power switch 106 and a carrying strap 108. This configuration provides several advantages including: an ultra compact design; cool-to-touch heat sinking; battery remaining indication and diagnostics via LEDs behind the frosted main lens or window; stackability with the foregoing lights; sealing from contaminants; no protruding switches, controls handles or brackets; and plugless charging via contacts in the case that sense then charge from a charging station.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A hand-carried light comprising:
a) a generally rectangular body with opposed faces, a peripheral edge having a width substantially less than the width of the faces, and a handle adjacent one end of the body; and
b) a plurality of spaced LED emitter heads mounted on one face of said body, each of said emitter heads including a housing and at least one LED emitter.

2. The light of claim 1, wherein said emitter heads are battery powered.

3. The light of claim 1, further including a hanging bracket attached to said body.

4. The light of claim 1, further including a carrying strap.

5. The light of claim 1, further including a pair of leads with magnetic connections attachable to a third rail.

6. The light of claim 5, wherein said connections include means for reducing the rail voltage.

7. The light of claim 1, further including a microprocessor controlled dc buck and boost to control the voltage to said emitter heads.

8. The light of claim 1, further including a battery module attachable to said emitter heads, said module having a battery, component circuitry providing charge monitoring, a fuel/power gauge, short circuit protection and low voltage cutoff.

9. A hand-carried, battery-powered light comprising:
a) an non-conductive enclosure having rectangular top and bottom walls and side and end walls connecting said top and bottom walls; and
b) a plurality of light sources mounted on said top wall carried on said top wall, each of said light sources including a support post having a base end and an outer end, and an emitter end attached to the outer end of said post.

10. The light of claim 9, wherein said post base ends are pivotally attached to said enclosure.

11. The light of claim 9, wherein said posts are telescoping.

12. The light of claim 9, wherein said light sources are pivotal.

13. The light of claim 9, wherein said top wall includes receiving recesses and said light sources are carried in said recesses.

14. The light of claim 9, including a carrying handle on said top wall.

15. The light of claim 9, wherein said enclosures are stackable.

16. The light of claim 9, wherein said light sources are detachable from said enclosure.

17. The light of claim 9, wherein said light sources include magnet attachment magnets.

18. The light of claim 9, including two of said light sources attached to said enclosure top wall parallel to said side walls and two of said light sources attached to said enclosure top wall parallel to said end walls.

19. The light of claim 9, housed within an outer housing having a light transmission opening.

20. A hand-carried, battery-powered light comprising:
a) an non-conductive enclosure having rectangular top and bottom walls and side and end walls connecting said top and bottom walls, said top wall including receiving recesses; and
b) a plurality of rotatable light sources mounted on said top wall in said recesses, each of said light sources including a telescopic support post having a base end pivotally attached to said top wall and an outer end, and an LED emitter head attached to the outer end of said post.
